(19) United States
(12) Patent Application Publication
(10) Pub. No.: US 2024/0354773 A1
(43) Pub. Date: Oct. 24, 2024

(54) ENVIRONMENTAL LOAD REDUCING SYSTEM AND ENVIRONMENTAL LOAD REDUCING METHOD

(71) Applicant: Hitachi, Ltd., Tokyo (JP)

(72) Inventors: Naoshi NISHI, Tokyo (JP); Atsushi SUTOH, Tokyo (JP)

(21) Appl. No.: 18/591,159

(22) Filed: Feb. 29, 2024

(30) Foreign Application Priority Data
Apr. 19, 2023 (JP) 2023-068519

(51) Int. Cl. G06Q 30/018

(52) U.S. Cl. CPC G06Q 30/018

(57) ABSTRACT

An environmental load reducing system is disclosed to enable a user desiring to contribute to reduction of environmental loads to examine a switch to a configuration reducing environmental loads. The environmental load reducing system compares configuration information associated with an operating system operated by a user with configuration information associated with a different operating system of a different user, to detect a difference between system components of these systems. The system also compares a calculation result of a carbon dioxide emission amount emitted by operation of the operating system for a fixed period of time with a calculation result of a carbon dioxide emission amount emitted by operation of the different operating system for the fixed period of time. A presentation unit presents the different system component as a low environmental load component according to the system component difference and in reference to a comparison result.

### CROSS-REFERENCE TO RELATED APPLICATION

The present application claims priority from Japanese application JP2023-068519, filed on Apr. 19, 2023, the content of which is hereby incorporated by reference into this application.

### BACKGROUND OF THE INVENTION

### 1. Field of the Invention

The present invention relates to an environmental load reducing system and an environmental load reducing method.

### 2. Description of the Related Art

With a recent increase in attention to environment-friendliness, ideas associated with carbon neutrality are spreading. Accordingly, efforts for reducing environmental loads during system operation are attracting attention. One of these efforts conventionally known is a technology which presents to a user a carbon dioxide emission amount of a system operated by the user (e.g., see JP-2001-332463-A).

JP-2001-332463-A discloses a technology which “measures a measurement item associated with a converted carbon dioxide generation amount of a device used for manufacturing semiconductors, calculates a measurement result thus obtained and a carbon dioxide generation amount conversion coefficient corresponding to the measurement item, obtains a sum total of calculation results as a carbon dioxide generation amount for each of the semiconductor manufacturing devices, and displays the total amount on display means to present this amount to the user.”

According to the conventional technology noted above, the carbon dioxide generation amount is merely presented to the user in the form of display. Accordingly, the user is able to know the carbon dioxide emission amount, but is unable to, by mere knowledge of the carbon dioxide emission amount, recognize a total lifecycle carbon dioxide emission amount of the operating system, or the presence or absence of a configuration which achieves performance substantially equivalent to performance of the operating system but has a smaller carbon dioxide emission amount. As a result, a user desiring to contribute to more reduction of environmental loads is unable to examine a switch to a configuration which further reduces environmental loads (i.e., a configuration which has a smaller carbon dioxide emission amount).

### SUMMARY OF THE INVENTION

The present invention has been developed in consideration of the abovementioned circumstances. An object of the present invention is to provide an environmental load reducing system and an environmental load reducing method for enabling a user desiring contribution to more reduction of environmental loads to examine a switch to a configuration which further reduces environmental loads.

For achieving the above object, an environmental load reducing system according to an aspect of the present invention includes a detection unit that compares configuration information associated with an operating system operated by a user with configuration information associated with a different operating system of a different user, to detect a difference between system components of the operating system and the different operating system, a comparison unit that compares a calculation result of a carbon dioxide emission amount emitted by operation of the operating system for a fixed period of time with a calculation result of a carbon dioxide emission amount emitted by operation of the different operating system for the fixed period of time, and a presentation unit that presents the different system component as a low environmental load component according to the difference between the system components and in reference to a comparison result obtained by the comparison unit.

Moreover, for achieving the above object, an environmental load reducing system according to another aspect of the present invention includes a grouping unit that divides system components mountable on an operating system operated by a user into groups according to single performance values of the system components, a comparison unit that compares a carbon dioxide emission amount of each of the system components mounted on the operating system with a carbon dioxide emission amount of a system component in a group identical to the group of the corresponding system component mounted on the operating system, and a presentation unit that presents a low environmental load component to the user. When the system component that has a smaller carbon dioxide emission amount than the corresponding system component mounted on the operating system is included in the system components in the identical group, the presentation unit presents the system component that has the smaller carbon dioxide emission amount to the user, as the low environmental load component.

Further, for achieving the above object, an environmental load reducing method according to an aspect of the present invention includes a step of comparing configuration information associated with an operating system operated by a user with configuration information associated with a different operating system of a different user, to detect a difference between system components of the operating system and the different operating system, a step of comparing a calculation result of a carbon dioxide emission amount emitted by operation of the operating system for a fixed period of time with a calculation result of a carbon dioxide emission amount emitted by operation of the different operating system for the fixed period of time and a step of presenting the different system component as a low environmental load component according to the difference between the system components and in reference to a result of the comparison.

The present invention enables a user desiring more contribution to reduction of environmental loads to examine a switch to a configuration which further reduces environmental loads.

Problems, configurations, and effects other than those described above will become apparent from the following description concerning a mode for carrying out the invention (hereinafter referred to as an embodiment).

### BRIEF DESCRIPTION OF THE DRAWINGS

FIG. 1 is an outline diagram schematically depicting an outline of an environmental load reducing system according to the present invention;

FIG. 2A is an explanatory diagram illustrating operation information, while FIG. 2B is an explanatory diagram illustrating information associated with a CO₂ emission amount for each of system mountable components;

Each of FIGS. 3A to 3C is an explanatory diagram illustrating grouping of system components mountable on an operating system;

FIG. 4 is a system configuration diagram schematically depicting an example of a system configuration of an environmental load reducing system according to an embodiment of the present invention;

FIG. 5 is a block diagram depicting an example of a configuration of a management server included in a client system operation information managing unit;

FIG. 6 is a diagram schematically illustrating a flow of processing procedures executed by the management server of the client system operation information managing unit for presenting a switch to a low environmental load component;

FIG. 7 is a diagram schematically illustrating an example of presentation executed by the management server of the client system operation information managing unit for presenting a switch to a low environmental load component;

FIG. 8 is a block diagram depicting an example of a configuration of a management server included in a device information managing unit;

FIG. 9 is a diagram schematically illustrating a flow of processing procedures executed by the management server of the device information managing unit for presenting a switch to a low environmental load component;

FIG. 10 is a diagram schematically illustrating an example of presentation executed by the management server of the device information managing unit for presenting a switch to a low environmental load component;

FIG. 11 is a block diagram depicting an example of a configuration of a client operation system;

FIG. 12 is a block diagram depicting an example of a configuration of an operation terminal at a client site;

FIG. 13 is a flowchart (1) illustrating an example of processing procedures of an environmental load reducing method according to the embodiment of the present invention;

FIG. 14 is a flowchart (2) illustrating an example of processing procedures of the environmental load reducing method according to the embodiment of the present invention; and

FIG. 15 is a system configuration diagram schematically depicting a system configuration of an environmental load reducing system according to a modification of the present invention.

### DESCRIPTION OF THE PREFERRED EMBODIMENT

A mode for carrying out the present invention (embodiment) will hereinafter be described with reference to the accompanying drawings. In the present description and the drawings, each of constituent elements having substantially the same function or configuration will be given the same reference number to omit repetitive explanation.

### <Outline of Environmental Load Reducing System of Present Invention>

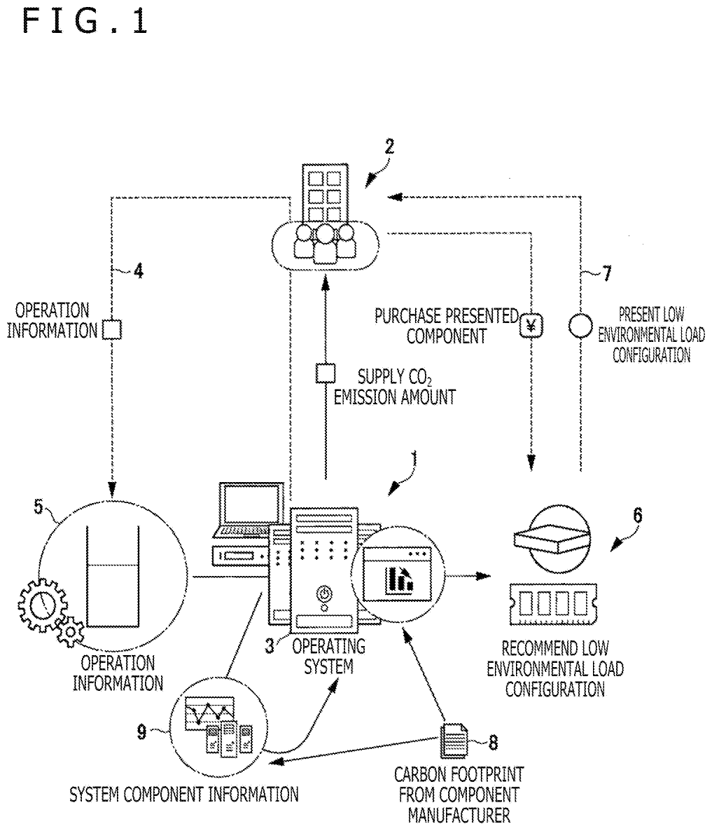

FIG. 1 is an outline diagram schematically depicting an outline of an environmental load reducing system according to the present invention. The environmental load reducing system of the present invention employs two methods to enable a user desiring more contribution to reduction of environmental loads to examine a switch to a configuration which reduces environmental loads (i.e., a configuration which has a smaller carbon dioxide (CO₂) emission amount).

### (First Method)

An environmental load reducing system 1 according to the present invention first compares configuration information associated with an operating system 3 operated by a user 2 with configuration information associated with a different operating system (not depicted) of a different user, to detect a difference in system component between the two systems. With regard to the configuration information associated with the different operating system of the different user as a comparison target, configuration information associated with a different operating system which has performance values substantially equivalent to performance values of the operating system may be acquired and stored beforehand in a database 5 via a route 4 to allow the configuration information to be obtained from the database 5 as operation information. It is assumed that the “equivalent” performance values are included in a range of −10% to +10% of the performance values of the operating system 3, for example.

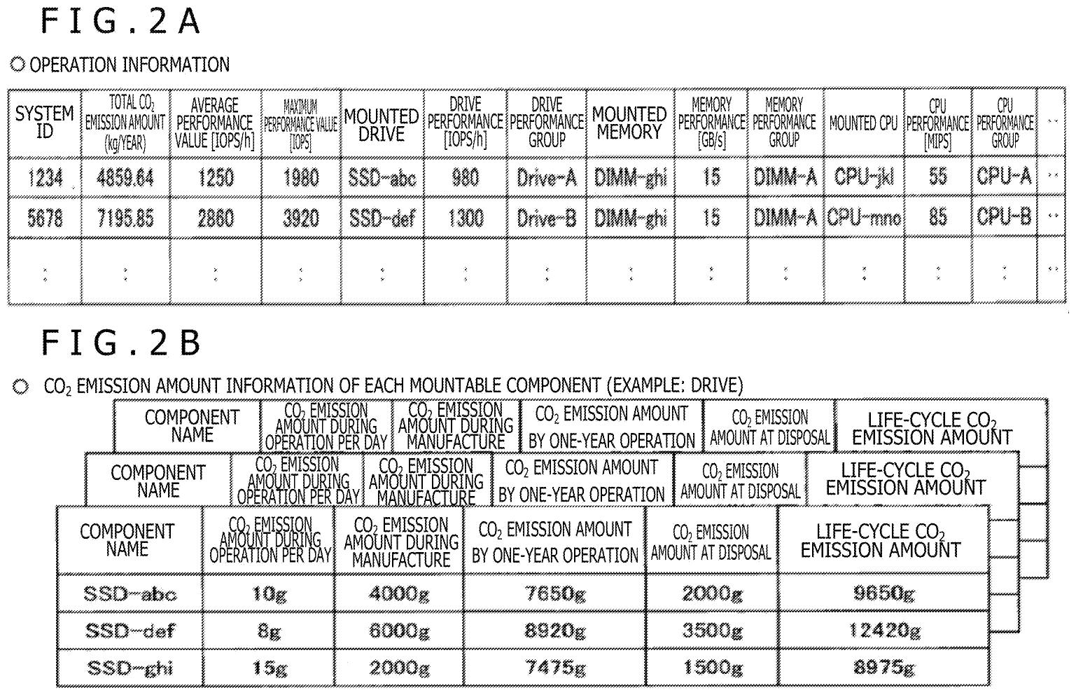

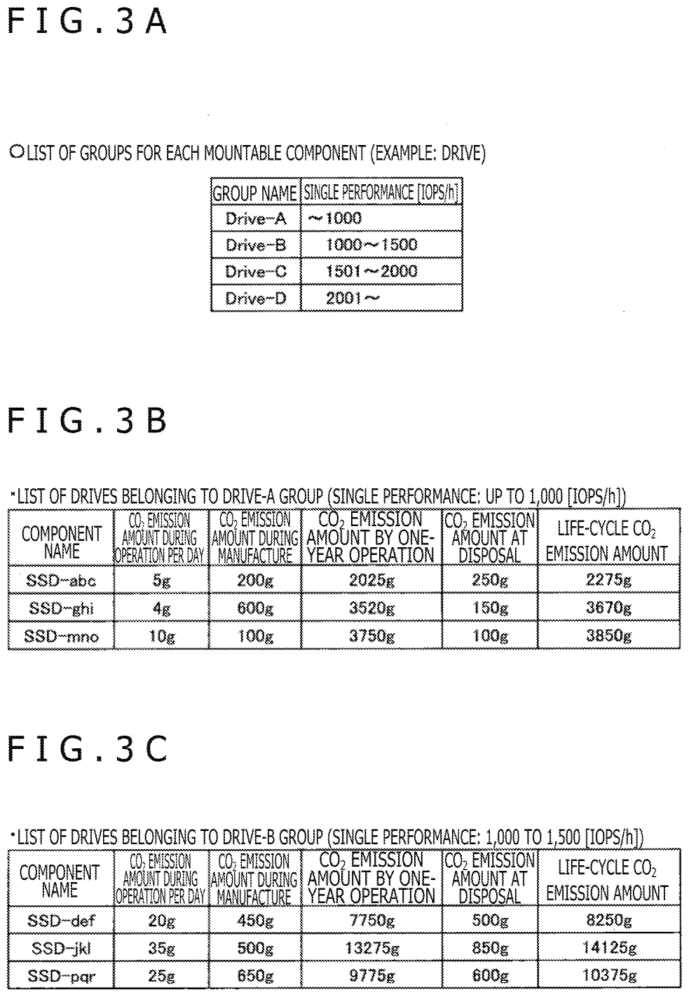

The “configuration information” herein refers to information associated with system components and the like constituting the system (operating system or different operating system). In addition, the “operation information” refers to information associated with power consumption, performance values, and the like. The operation information includes information associated with components and the like constituting the system (configuration information). FIG. 2A illustrates an example of the operation information. The operation information in this example includes, for each system ID, respective items of information such as a total CO₂ emission amount (kg/year), an average performance value [IOPS/h], a maximum performance value [IOPS], a mounted drive, drive performance [IOPS/h], a drive performance group, a mounted memory, memory performance [GB/s], a memory performance group, a mounted central processing unit (CPU), CPU performance [MIPS], and a CPU performance group.

After detection of the system component difference, a comparison is made between a calculation result of a CO₂ emission amount emitted by operation of the operating system 3 for a fixed period of time and a calculation result of a CO₂ emission amount emitted by operation of the different operating system for the same fixed period of time. FIG. 2B illustrates information associated with a CO₂ emission amount for each of components mountable on the system (e.g., drive). This information associated with the CO₂ emission amount for each of the mountable components has respective items of information including a CO₂ emission amount during operation per day, a CO₂ emission amount during manufacture, a CO₂ emission amount by one-year operation, a CO₂ emission amount at the time of disposal, and a lifecycle CO₂ emission amount for each of the mountable components.

Which of the operating system 3 and the different operating system has a smaller CO₂ emission amount can be determined by a process of comparison between the calculation result of the CO₂ emission amount emitted by operation of the operating system 3 for the fixed period of time and the calculation result of the CO₂ emission amount emitted by operation of the different operating system for the same fixed period of time.

If the calculation result of the CO₂ emission amount of the different operating system is smaller than that amount of the operating system 3 according to the comparison process described above, the system component that is included in the different operating system and that is different from the corresponding component of the operating system 3 is presented to the user 2 as a low environmental load component 6 according to a difference in system component between the operating system 3 and the different operating system (route 7).

This presentation of the low environmental load component 6 can prompt the user 2 as the environmental load reduction target to switch the system component to the low environmental load component 6. In this manner, the user desiring to contribute more to reduction of environmental loads is enabled to examine a switch to a configuration which reduces environmental loads. Specifically, the user 2 having received the presentation of the switch to the low environmental load component 6 can purchase the presented low environmental load component 6 and replace the system component with the low environmental load component 6 to switch the operating system 3 to one having a configuration reducing the CO₂ emission amount. In this manner, contribution to reduction of the CO₂ emission amount and reduction of power consumption is achievable.

In this case, the performance values of the different operating system of the different user as the comparison target are substantially equivalent to the performance values of the operating system. Accordingly, the system component included in the different operating system having performance values closer to those values of the operating system 3 can be presented to the user 2, as the low environmental load component 6.

Meanwhile, if the calculation result of the CO₂ emission amount of the operating system 3 is smaller than that result of the different operating system according to the comparison result obtained by the comparison process described above, a switch from the operating system 3 to one having a lower environmental load configuration need not be examined. In this case, however, the different user may be prompted to switch the system component of the different operating system.

Specifically, if the calculation result of the CO₂ emission amount of the operating system 3 is smaller than that result of the different operating system, the system component that is included in the operating system 3 and that is different from the corresponding component of the different operating system may be presented to the different user, as the low environmental load component 6. This presentation of the low environmental load component 6 can prompt the different user to switch the system component of the different operating system. As a result, contribution to reduction of the CO₂ emission amount and reduction of power consumption is achievable by not only the user 2 as the environment load reduction target, but also the different user who is not the environment load reduction target.

### (Second Method)

The first method described above presents the low environmental load component 6 to the user in reference to a result of a comparison with the configuration information associated with the different operating system which is operated by the different user who is not the environmental load reduction target. Meanwhile, the second method divides the system components mountable on the operating system into groups according to each single performance value of these system components, and presents the system component having a smaller CO₂ emission amount than the corresponding system component mounted on the operating system 3 to the user, as the low environmental load component 6 in reference to a comparison between CO₂ emission amounts of the system components belonging to the same group.

Specifically, the second method imports system component information from carbon footprints 8 given from a component manufacturer, divides system components mountable on the operating system into groups according to each single performance value of the system components mountable on the operating system, and stores the divided system components in a database 9. Thereafter, the second method compares CO₂ emission amounts of the system components mounted on the operating system 3 with CO₂ emission amounts of the system components in the same group, and extracts, as the low environmental load component 6, the system component having a smaller CO₂ emission amount than the corresponding system component mounted on the operating system 3.

Each of FIGS. 3A to 3C is an explanatory diagram illustrating grouping of the system components mountable on the operating system. FIG. 3A is a list of groups presented for each component (e.g., drive) mountable on the operating system. Meanwhile, FIG. 3B is a list of drives belonging to Drive-A group (single performance: up to 1,000 [IOPS/h]), and FIG. 3C is a list of drives belonging to Drive-B group (single performance: 1,000 to 1,500 [IOPS/h]).

The process of comparison between the CO₂ emission amounts of the system components mounted on the operating system 3 and the CO₂ emission amounts of the system components in the same group can determine whether or not the system components in the same group include such a system component which has a smaller CO₂ emission amount than the corresponding system component mounted on the operating system 3. If the system component having a smaller CO₂ emission amount than the corresponding system component mounted on the operating system 3 is not included, a switch to a lower environmental load configuration need not be examined.

If the system component having a smaller CO₂ emission amount than the corresponding system component mounted on the operating system 3 is included in the system components in the same group, this system component having a smaller CO₂ emission amount is presented to the user 2 as the low environmental load component 6. This presentation of the low environmental load component 6 can prompt the user 2 to switch the system component. In this manner, the user desiring to contribute to reduction of environmental loads is enabled to examine a switch to a configuration which reduces environmental loads.

The user 2 having received the presentation of the low environmental load components 6 can practice switching to a configuration having a lower CO₂ emission amount, by purchasing the system component presented as the low environmental load component 6 and replacing the system component determined to have a large CO₂ emission amount with the purchased system component. In this manner, contribution to reduction of the CO₂ emission amount and reduction of power consumption is achievable.

The second method divides the system components mountable on the operating system into groups according to each single performance value of these system components for the following reason. Typically, a system component having a relatively excellent single performance value is more expensive than a system component having a relatively poor single performance value. Accordingly, without grouping according to single performance values, an expensive system component may be presented as the low environmental load component 6. In other words, a system component that has a substantially equivalent performance value and that falls within a substantially equivalent price range for the system components of the operating system 3 is presentable to the user as the low environmental load component 6, by grouping according to single performance values.

### <Environmental Load Reducing System According to Embodiment of Present Invention>

### System Configuration Example

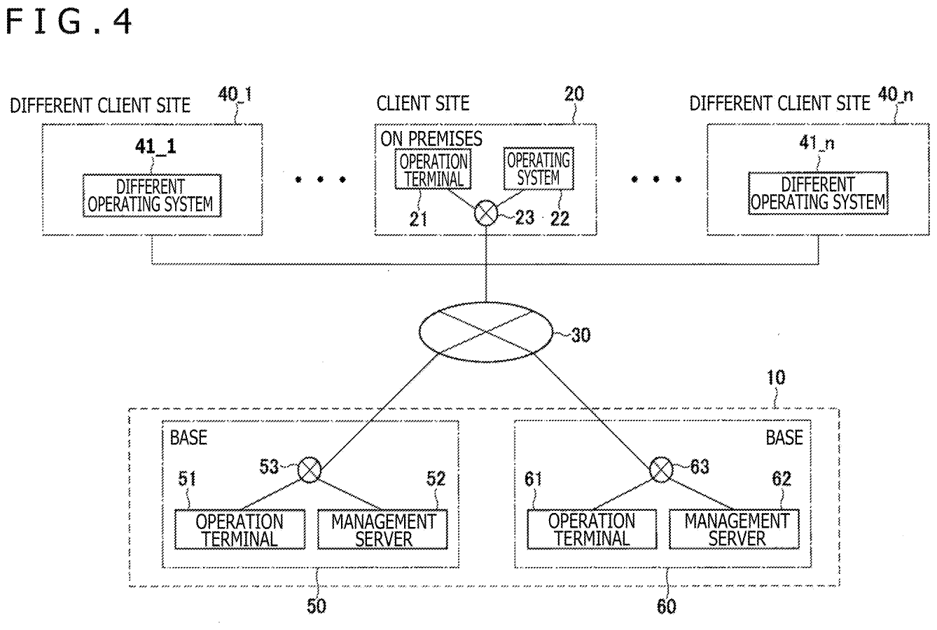

FIG. 4 is a system configuration diagram schematically depicting an example of a system configuration of an environmental load reducing system according to the embodiment of the present invention.

An environmental load reducing system 10 according to the embodiment of the present invention is connected via a network 30 to a client site 20 provided on premises (data center). In addition to the client site 20, client sites 40_1 to 40_n of different users are also connected to the network 30. The client sites 40_1 to 40_n of the different users have different operating systems 41_1 to 41_n, respectively. The different operating systems 41_1 to 41_n may sometimes also collectively be referred to as a different operating system 41 hereinafter.

The environmental load reducing system 10 provided as a base includes a client system operation information managing unit 50 and a device information managing unit 60. The client site 20 includes an operation terminal 21, an operating system 22, and a local area network (LAN) 23. When the client site 20 is designated as an environmental load reduction target site, the operating system 22 is considered as an operating system operated by the user. For example, the operating system 22 is a storage, a server, or the like.

The client system operation information managing unit 50 of the environmental load reducing system 10 includes an operation terminal 51, a management server 52, and a LAN 53. The client system operation information managing unit 50 thus configured executes the process of the first method described above, i.e., a process which presents a different system component to the user as a low environmental load component according to a difference in system component between the operating system 22 of the client site 20 and the operating systems 41 of the different client sites 40_1 to 40_n.

The device information managing unit 60 includes an operation terminal 61, a management server 62, and a LAN 63. The device information managing unit 60 thus configured executes the process of the second method described above, i.e., a process which divides the system components mountable on the operating system into groups, and presents a system component having a smaller CO₂ emission amount than the corresponding system component mounted on the operating system to the user as a low environmental load component, if the system component having a smaller CO₂ emission amount is included in the system components in the same group.

### [Management Server of Client System Operation Information Managing Unit]

### (Configuration Example of Management Server)

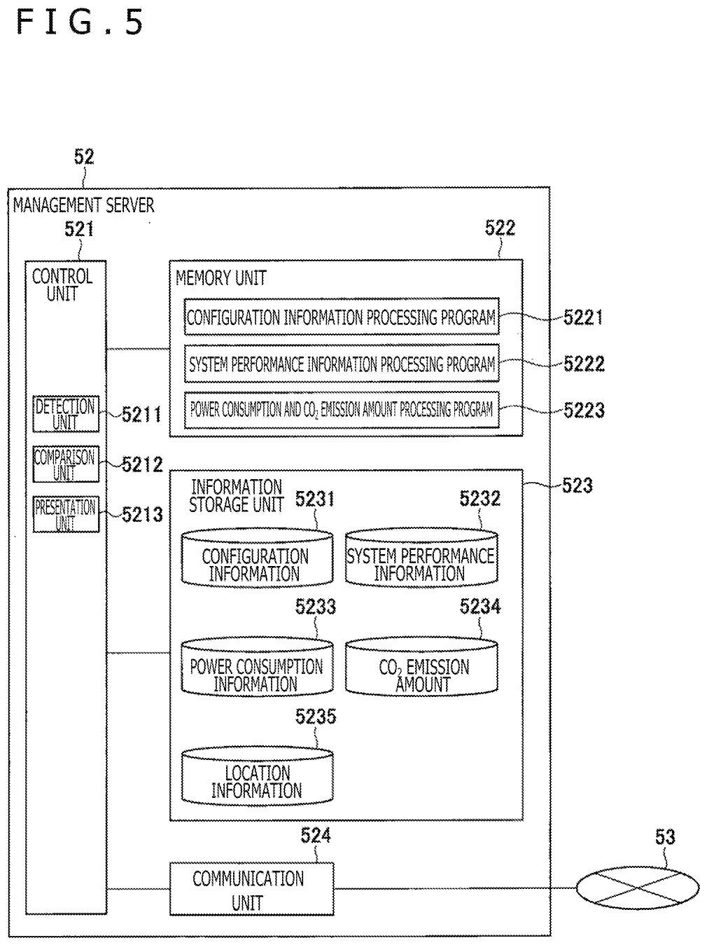

FIG. 5 is a block diagram depicting an example of a configuration of the management server 52 included in the client system operation information managing unit 50.

The management server 52 of the client system operation information managing unit 50 includes a control unit 521, a memory unit 522, an information storage unit 523, and a communication unit 524.

While not depicted in the figure, the control unit 521 includes a CPU, a read only memory (ROM), a random access memory (RAM), and others. The CPU reads a program associated with processing contents from the ROM, decompresses the read program in the RAM, and performs centralized control of operations of the management server 52 in cooperation with the decompressed program.

The memory unit 522 includes a configuration information processing program 5221, a system performance information processing program 5222, and a power consumption and CO₂ emission amount processing program 5223. The information storage unit 523 includes a configuration information database (DB) 5231, a system performance information database 5232, a power consumption information database 5233, a CO₂ emission amount database 5234, and a location information database 5235.

The configuration information processing program 5221 of the memory unit 522 is a program for importing information associated with components (system components) constituting a client operation system (the operating system 22 operated by the user) and the different operating systems 41 of the different users. The configuration information processing program 5221 stores the information associated with the system components and imported from the client operation system in the configuration information database 5231 of the information storage unit 523.

The system performance information processing program 5222 is a program for importing information associated with performance values of the client operation system and given from the client operation system. The system performance information processing program 5222 stores the information associated with the performance values and imported from the client operation system in the system performance information database 5232 of the information storage unit 523.

The power consumption and CO₂ emission amount processing program 5223 is a program for acquiring information associated with the power consumption and the CO₂ emission amount of the client operation system and given from the client operation system. The power consumption and CO₂ emission amount processing program 5223 stores the power consumption acquired form the client operation system in the power consumption information database 5233, and stores the information associated with the CO₂ emission amount in the CO₂ emission amount database 5234.

Location information associated with a client site, i.e., information indicating an installation place of the client site 20 corresponding to the environmental load reduction target and information indicating installation places of the client sites 40_1 to 40_n other than the environmental load reduction target in the example of FIG. 2, are stored in the location information database 5235 of the information storage unit 523 beforehand.

The control unit 521 included in the management server 52 of the client system operation information managing unit 50 configured as above includes respective functions corresponding to a detection unit, a comparison unit, and a presentation unit according to the claims, i.e., a detection unit 5211, a comparison unit 5212, and a presentation unit 5213.

The detection unit 5211 of the control unit 521 performs a process which compares configuration information associated with the operating system and stored in the configuration information database 5231 with configuration information associated with the different operating system and stored in the configuration information database 5231, to detect a difference in system component between the two systems. For the configuration information associated with the different operating system 41 as a comparison target, configuration information associated with the different operating system 41 which has performance values substantially equivalent (e.g., ±10%) to performance values of the operating system may be acquired from the configuration information database 5231.

The comparison unit 5212 performs a process which compares a calculation result of a CO₂ emission amount emitted by operation of the operating system 22 for a fixed period of time with a calculation result of a CO₂ emission amount emitted by operation of the different operating system 41 for the same fixed period of time, in reference to information associated with CO₂ emission amounts and the like and stored in the CO₂ emission amount database 5234. This comparison process performed by the comparison unit 5212 can determine which of the operating system 22 and the different operating system 41 has a smaller CO₂ emission amount.

The presentation unit 5213 performs a process which presents a different system component as a low environmental load component in reference to the comparison result obtained by the comparison unit 5212, according to the difference in system component detected by the detection unit 5211. Specifically, if the calculation result of the CO₂ emission amount of the different operating system 41 is smaller than that result of the operating system 22, the control unit 521 transfers information concerning the system component that is included in the different operating system 41 and that is different from the corresponding component of the operating system, as a low environmental load component, to the client site 20 (see FIG. 4) from the communication unit 524 via the LAN 53 to present this system component to the user.

This presentation of the low environmental load component can prompt the user as the environmental load reduction target to switch the system component. In this manner, the user desiring to contribute to reduction of environmental loads is enabled to examine a switch to a configuration which reduces environmental loads. Specifically, the user can contribute to reduction of the CO₂ emission amount and reduction of power consumption by receiving presentation of the low environmental load component and adopting the system configuration corresponding to the low environmental load configuration.

### (Example of Process for Presentation of Switch to Low Environmental Load Component)

Described next will be an example of processing procedures performed by the management server 52 of the client system operation information managing unit 50 to present a switch to a low environmental load component.

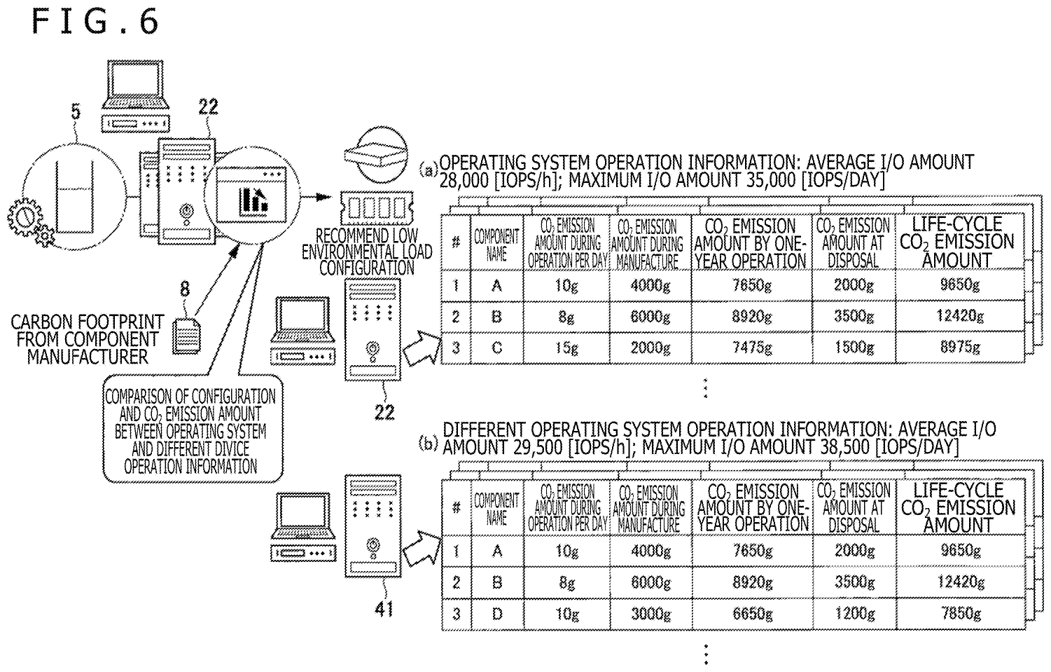

The process performed for presenting the switch to the low environmental load component that is illustrated here by way of example is the process of the first method described above, i.e., a process which makes a performance comparison with the system that is included in the different operating systems 41 (41_1 to 41_n) and that is similar to the operating system 22, in reference to the operation information, and presents a switch of the system component, and is a process executed under control by the control unit 521 of the management server 52. FIG. 6 is a diagram schematically illustrating a flow of processing procedures for presenting a switch to a low environmental load component that are executed by the management server 52 of the client system operation information managing unit 50.

First, the control unit 521 imports CO₂ emission amounts by time unit emitted during use of the system components mounted on the operating system 22 currently operating into the CO₂ emission amount database 5234, in reference to heat values of these system components. The control unit 521 further imports lifecycle CO₂ emission amounts of the components mountable on the operating system 22 into the CO₂ emission amount database 5234 in reference to the carbon footprints 8 for the system components.

Subsequently, the control unit 521 sums CO₂ emission amounts of the system components constituting the operating system 22 to calculate a total value of CO₂ emission amounts to be emitted if the system continues operation for a fixed period of time (e.g., one year) in the future. The control unit 521 further selects a configuration having a performance value substantially equivalent (e.g., throughput: ±10%) to that value of the operating system 22 from the operation information acquired from the different operating systems 41 operated by the different users (different device operation information), and compares the selected configuration of the different operating system 41 with the configuration of the operating system 22.

Next, the control unit 521 compares a calculation result of a CO₂ emission amount emitted by operation of the operating system 22 for the fixed period of time with a calculation result of a CO₂ emission amount emitted by operation of the different operating system 41 for the same fixed period of time. Thereafter, the control unit 521 detects a difference in system component between the operating system 22 and the different operating system 41 in reference to a result of the comparison between the CO₂ emission amount calculation results, and presents the different system component to the user as a low environmental load component to prompt a switch (replacement) of the system component.

In FIG. 6, (a) illustrates operation information associated with the operating system 22 (average I/O amount: 28,000 [IOPS/h], maximum I/O amount: 35,000 [IOPS/day]), while (b) illustrates operation information associated with the different operating system 41 (average I/O amount: 29,500 [IOPS/h], maximum I/O amount: 38,500 [IOPS/day]).

A CO₂ emission amount of the operating system 22 operated for one year without a switch of the system configuration is 3,562.67 kg. A CO₂ emission amount of the different operating system 41 operated for one year without a switch of the system configuration is 2,938.50 kg.

As described above, the process performed by the management server 52 of the client system operation information managing unit 50 to present a switch to a low environmental load component presents a difference in system component in reference to a result of a comparison between a CO₂ emission amount of the operating system 22 and a CO₂ emission amount of the different operating system 41, and presents the different system component to the user as a low environmental load component. According to the present embodiment, a switch from a system component C of the operating system 22 to a system component D of the different operating system 41 is presented to the user. This switch (replacement) of the system component can contribute to reduction of the CO₂ emission amount and reduction of power consumption of the operating system 22.

### (Example of Presentation of Switch to Low Environmental Load Component)

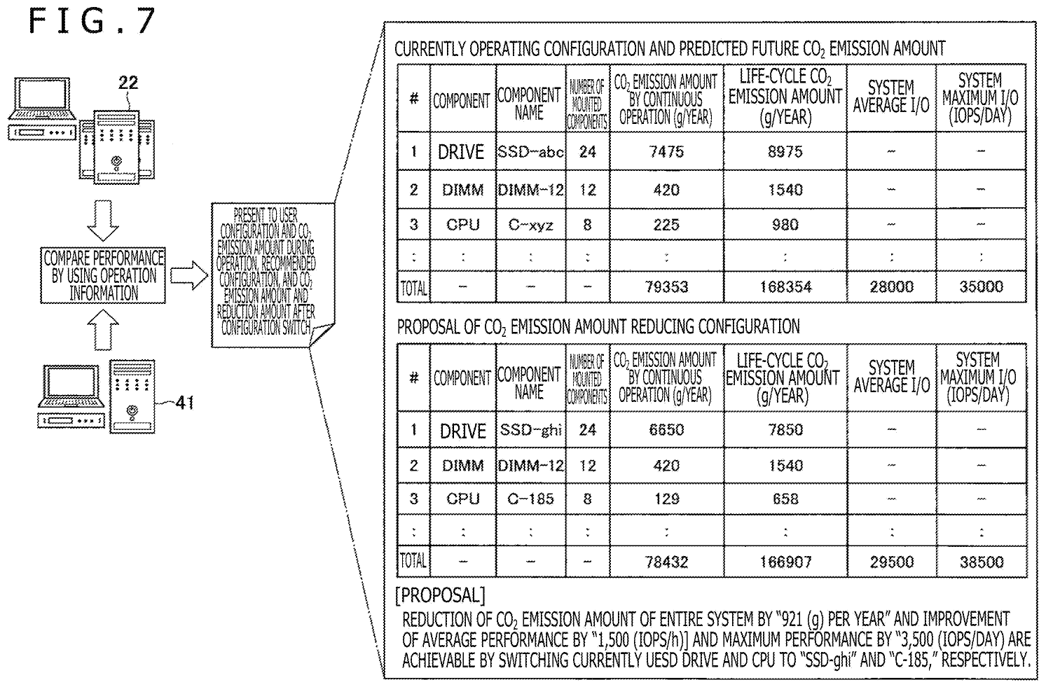

Described next will be an example of processing procedures that are executed by the management server 52 of the client system operation information managing unit 50 and that adopt the first method described above to present a switch to a low environmental load component. FIG. 7 is a diagram schematically illustrating an example of presentation of a switch to a low environmental load component that is executed by the management server 52 of the client system operation information managing unit 50.

The first method is a process which compares performance between the operating system 22 and the system that is included in the different operating systems 41 (41_1 to 41_n) and that is similar to the operating system 22 in reference to the operation information, and presents a switch of the system component in reference to a result of this performance comparison.

The management server 52 of the client system operation information managing unit 50 using the first method described above performs a process which compares performance in reference to the operation information, and presents, together with a message, a current operating configuration and prediction of a future CO₂ emission amount for each system component, and proposal of a CO₂ emission amount reduction configuration for each system component.

A drive, a dual inline memory module (DIMM), and a CPU are presented here as the system components mounted on the operating system 22 by way of example. In this case, it is assumed that a CO₂ emission amount emitted by continuous operation is 7,475 (g/year) from a drive with a component name of SSD-abc, 420 (g/year) from a DIMM with a component name of DIMM-12, and 225 (g/year) from a CPU with a component name of C-xyz.

Meanwhile, it is assumed that a CO₂ emission amount emitted by continuous operation of the different operating system 41 corresponding to a comparison target is 6,650 (g/year) from a drive with a component name of SSD-ghi, 420 (g/year) from a DIMM with the component name of DIMM-12, and 129 (g/year) from a CPU with a component name of C-185.

In reference to a result of the foregoing performance comparison, a message that reads “reduction of the CO₂ emission amount of the entire system by ‘921 (g) per year’ and average performance of ‘1,500 (IOPS/h)’ and maximum performance of ‘3,500 (IOPS/day)’ are achievable by switching the currently used drive to ‘SSD-ghi’ and the CPU to ‘C-185’” is presented to the user.

The user having received this proposal can contribute to reduction of the CO₂ emission amount and reduction of power consumption of the operating system 22 by replacing the SSD-abc drive and the C-xyz CPU included in the system components mounted on the operating system 22 with the SSD-ghi drive and the C-185 CPU, respectively.

### [Management Server of Client System Operation Information Managing Unit]

### (Configuration Example of Management Server)

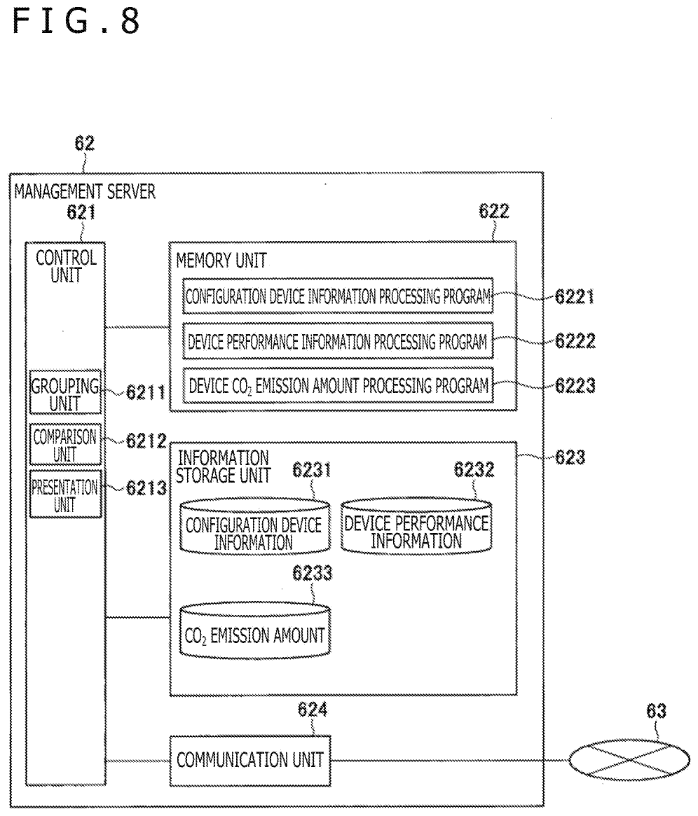

FIG. 8 is a block diagram depicting an example of a configuration of the management server 62 included in the device information managing unit 60.

The management server 62 of the device information managing unit 60 includes a control unit 621, a memory unit 622, an information storage unit 623, and a communication unit 624.

While not depicted in the figure, the control unit 621 includes a CPU, a ROM, a RAM, and others. The CPU reads a program associated with processing contents from the ROM, decompresses the read program in the RAM, and performs centralized control of operations of the management server 62 in cooperation with the decompressed program.

The memory unit 622 includes a configuration device information processing program 6221, a device performance information processing program 6222, and a device CO₂ emission amount processing program 6223. The information storage unit 623 includes a configuration device information database 6231, a device performance information database 6232, and a CO₂ emission amount database 6233.

The configuration device information processing program 6221 of the memory unit 622 is a program for acquiring information associated with the system components mounted on the operating system from carbon footprints given from the component manufacturer. The configuration device information processing program 6221 stores the information associated with the system components acquired from the carbon footprints in the configuration device information database 6231 of the information storage unit 623.

The device performance information processing program 6222 is a program for acquiring information associated with performance values of the system components mounted on the operating system. The device performance information processing program 6222 stores the information associated with the performance values of the system components and acquired from the operating system in the device performance information database 6232 of the information storage unit 623.

The device CO₂ emission amount processing program 6223 is a program for acquiring information indicating levels of CO₂ emission amounts of the system components mounted on the operating system. The device CO₂ emission amount processing program 6223 stores the information associated with the CO₂ emission amounts from the system components and acquired from the operating system in the CO₂ emission amount database 6233 of the information storage unit 623.

The control unit 621 of the management server 62 included in the device information managing unit 60 configured as above includes respective functions corresponding to a grouping unit, a comparison unit, and a presentation unit according to the claims, i.e., a grouping unit 6211, a comparison unit 6212, and a presentation unit 6213.

The grouping unit 6211 of the control unit 621 imports information associated with the system components from carbon footprints given from the component manufacturer, and stores the imported information in the device performance information database 6232 of the information storage unit 623. Thereafter, the grouping unit 6211 divides the system components mountable on the operating system into groups according to each single performance value of these system components.

The comparison unit 6212 compares CO₂ emission amounts of the system components mounted on the operating system with CO₂ emission amounts of the system components in the same group in reference to information stored in the CO₂ emission amount database 6233. This comparison process performed by the comparison unit 6212 can determine whether or not a system component having a smaller CO₂ emission amount than the corresponding system component mounted on the operating system is included in the system components in the same group.

If it is determined in the comparison process performed by the comparison unit 6212 that the system component having a smaller CO₂ emission amount than the corresponding system component mounted on the operating system is included in the system components in the same group, the presentation unit 6213 transfers information concerning this system component as a low environmental load component from the communication unit 624 to the client site 20 (see FIG. 4) via the LAN 63 to present the corresponding system component to the user.

This presentation of the low environmental load component can prompt the user as the environmental load reduction target to switch the system component. In this manner, the user desiring to contribute to reduction of environmental loads is enabled to examine a switch to a configuration which reduces environmental loads. Specifically, the user can contribute to reduction of the CO₂ emission amount and reduction of power consumption by receiving presentation of the low environmental load component and adopting the system configuration corresponding to the low environmental load configuration.

### (Example of Process for Presentation of Switch to Low Environmental Load Component)

Described next will be an example of processing procedures performed by the management server 62 of the device information managing unit 60 to present a switch to a low environmental load component.

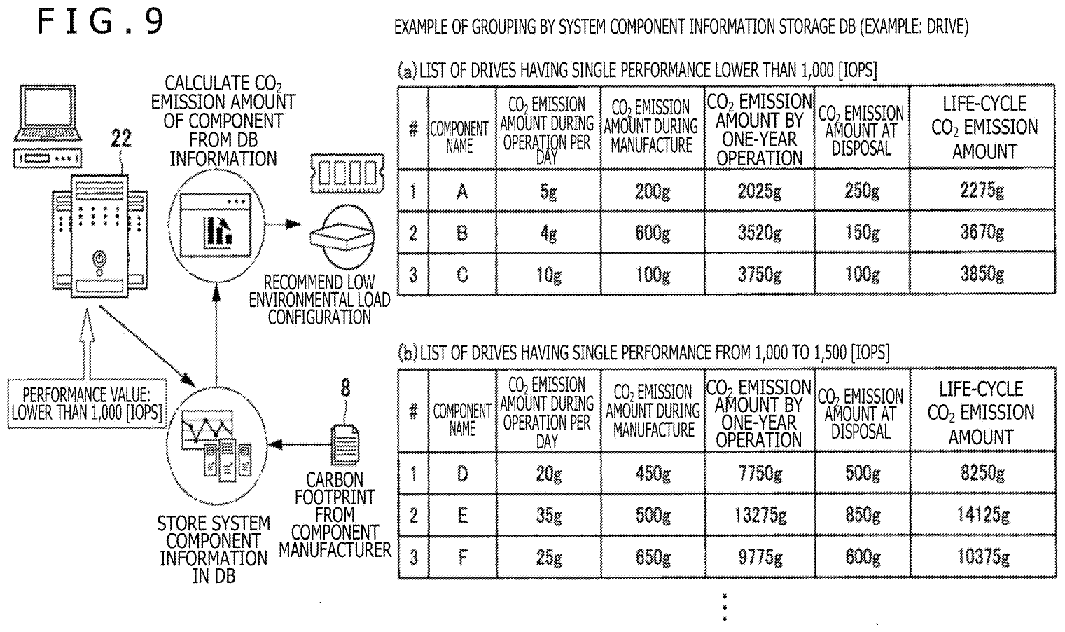

The process for presenting a switch to a low environmental load component that is described here by way of example is the process of the second method described above, i.e., a process which divides the system components mountable on the operating system into groups according to each single performance value of these system components, and presents the low environmental load component 6 to the user in reference to a comparison with CO₂ emission amounts of system components belonging to the same group. FIG. 9 is a diagram schematically illustrating a flow of processing procedures executed by the management server 62 of the device information managing unit 60 for presenting a switch to a low environmental load component.

First, the control unit 621 imports CO₂ emission amounts by time unit during use of system components mounted on the operating system 22 currently operating into the CO₂ emission amount database 6233 in reference to heat values of these system components.

Next, the control unit 621 divides the system components (e.g., drive) mountable on the operating system 22 into groups according to each single performance value of these system components, and then imports a total value of CO₂ emission amounts emitted by operation of each of the respective system components for a fixed period of time (e.g., one year) in the future into the CO₂ emission amount database 6233.

Thereafter, the control unit 621 compares a calculation result of the CO₂ emission amount emitted by operation of each of the system components on the operating system 22 for the fixed period of time with a calculation result of a CO₂ emission amount of a system component included in the same group as the group of the corresponding system component on the operating system 22. Thereafter, if the system component having a smaller CO₂ emission amount than the corresponding system component mounted on the operating system 22 is included in the system components in the same group, the system component having the smaller CO₂ emission amount is presented to the user as a low environmental load component to prompt the user to switch (replace) the system component.

In FIG. 9, (a) illustrates a drive list of a first group, such as a group of drives each having a single performance value lower than 1,000 [IOPS], while (b) illustrates a drive list of a group of drives each having a single performance value in a range of 1,000 to 1,500 [IOPS]. In this example, the drive list (a) of the group of drives each having a single performance value lower than 1, 000 [IOPS], for example, is selected in reference to the performance values of the operating system 22 by way of example. Thereafter, a comparison is made with the CO₂ emission amounts of the system components used by the user, and a difference is presented to the user to present a switch to a low environmental load component.

As described above, the process performed by the management server 62 of the device information managing unit 60 to present a switch to a low environmental load component makes a comparison according to a performance difference from the system components of the operating system 22, and presents a system component having a small CO₂ emission amount to the user as a low environmental load component. This switch (replacement) of the system component can contribute to reduction of the CO₂ emission amount and reduction of power consumption of the operating system 22.

### (Example of Presentation of Switch to Low Environmental Load Component)

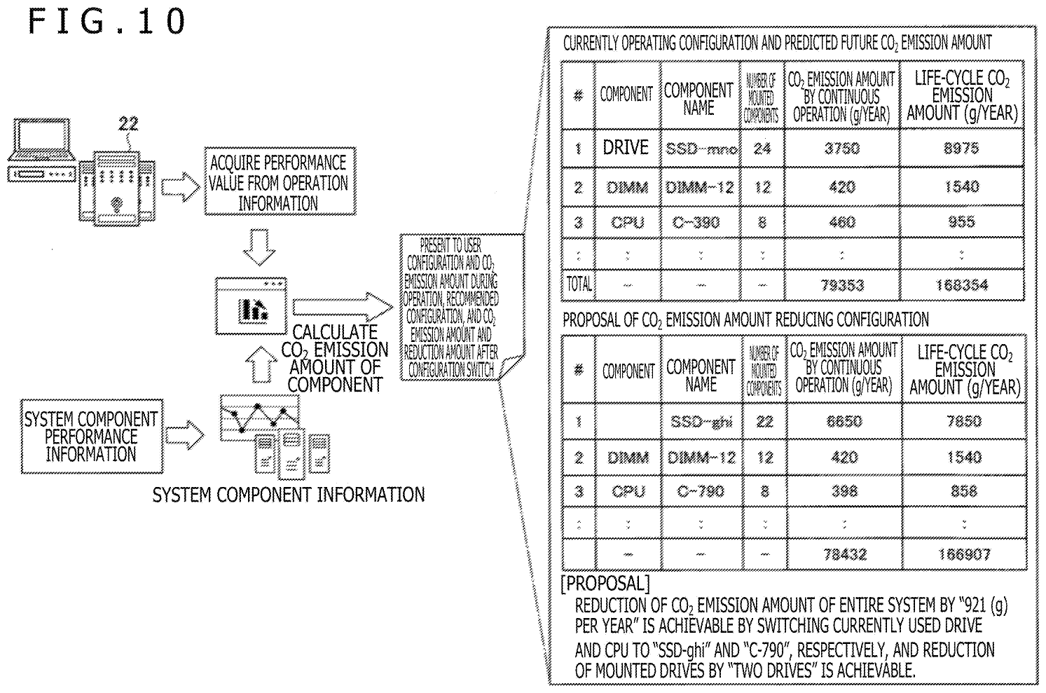

Described next will be an example of processing procedures that are executed by the management server 62 of the device information managing unit 60 and that adopt the second method described above to present a switch to a low environmental load component. FIG. 10 is a diagram schematically illustrating an example of presentation executed by the management server 62 of the device information managing unit 60 for presenting a switch to a low environmental load component.

The second method divides the system components mountable on the operating system 22 into groups according to each single performance value of these system components. Thereafter, the second method recommends a system component having a smaller CO₂ emission amount than the corresponding system component mounted on the operating system to the user as a low environmental load component in reference to a comparison with CO₂ emission amounts of the system components belonging to the same group.

The management server 62 of the device information managing unit 60 using the second method described above performs a process which acquires respective performance values of the system components mounted on the operating system 22, calculates CO₂ emission amounts of the system components in reference to performance information associated with the system components, and presents, together with a proposal message, a configuration and a CO₂ emission amount during operation, a recommended configuration, and a CO₂ emission amount and a reduction amount after a configuration switch.

A drive, a DIMM, and a CPU are presented here as the system components mounted on the operating system 22 by way of example. In this case, it is assumed that a CO₂ emission amount emitted by continuous operation is 3,750 (g/year) from 24 SSD-mno drives, 420 (g/year) from 12 DIMM-12 DIMMs, and 460 (g/year) from 8 C-390 CPUs.

Meanwhile, it is assumed that a CO₂ emission amount emitted by continuous operation of the proposed CO₂ emission amount reduction configuration is 6,650 (g/year) from 22 SSD-ghi drives, 420 (g/year) from 12 DIMM-12 DIMMs, and 398 (g/year) from 8 C-790 CPUs.

In reference to a result of the foregoing performance comparison, a message that reads “reduction of the CO₂ emission amount from the entire system by ‘921 (g) per year’ is achievable by switching the drive currently used to ‘SSD-ghi7 and the CPU to ‘C-780,’ and reduction of ‘two’ drives is further achievable” is presented to the user.

The user having received this proposal can contribute to reduction of the CO₂ emission amount and reduction of power consumption of the operating system 22 by replacing the SSD-mno drive with the SSD-ghi drive, decreasing the number of the mounted drives to 22, and replacing the C-390 CPU with the C-790 CPU for the system components mounted on the operating system 22.

### [Configuration Example of Client Operation System]

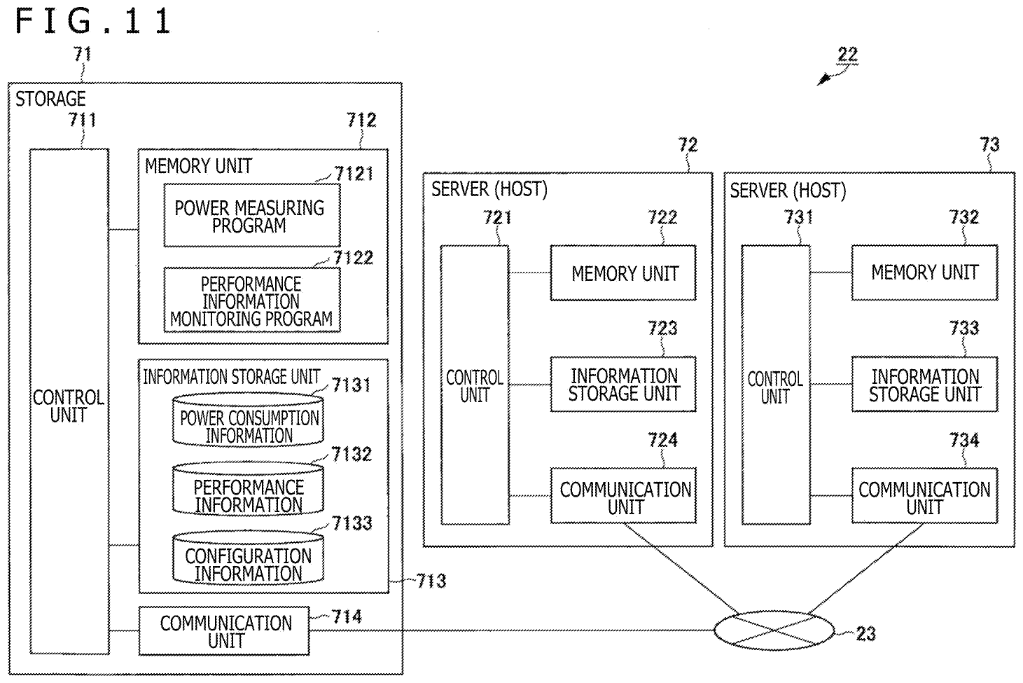

FIG. 11 is a block diagram depicting an example of a configuration of the operating system 22. The operating system 22 includes a storage 71, and components such as two servers (hosts) 72 and 73.

The storage 71 includes a control unit 711, a memory unit 712, an information storage unit 713, and a communication unit 714.

While not depicted in the figure, the control unit 711 includes a CPU, a ROM, a RAM, and others. The CPU reads a program associated with processing contents from the ROM, and decompresses the program in the RAM to perform centralized control of operations of the storage 71 in cooperation with the decompressed program.

The memory unit 712 includes a power measuring program 7121 and a performance information monitoring program 7122. The information storage unit 713 includes a power consumption information database 7131, a performance information database 7132, and a configuration information database 7133.

The power measuring program 7121 included in the memory unit 712 is a program for measuring power used by the storage 71. The power measuring program 7121 stores the measured power consumption of the storage 71 in the power consumption information database 7131 of the information storage unit 713.

The performance information monitoring program 7122 is a program for monitoring performance information associated with system components constituting the storage 71, and stores this performance information in the performance information database 7132. The configuration information database 7133 includes configuration information associated with the system components constituting the storage 71.

The server 72 includes a control unit 721, a memory unit 722, an information storage unit 723, and a communication unit 724. Similarly to the server 72, the server 73 includes a control unit 731, a memory unit 732, an information storage unit 733, and a communication unit 734.

As described above, the user who operates the operating system 22 including the storage 71 and the components such as the two servers 72 and 73 receives presentation of a switch to a low environmental load component from the environmental load reducing system 10 including the client system operation information managing unit 50 and the device information managing unit 60, and replaces the system component with the low environmental load component. Examples of the replacement target device in this case include not only the system component constituting the storage 71, but also the two servers 72 and 73.

### [Configuration Example of Operation Terminal]

Described next will be a configuration example of the operation terminal 21 of the client site 20, the operation terminal 51 of the client system operation information managing unit 50, and the operation terminal 61 of the device information managing unit 60. A configuration of the operation terminal 21 included in the client site 20 will be explained here by way of example.

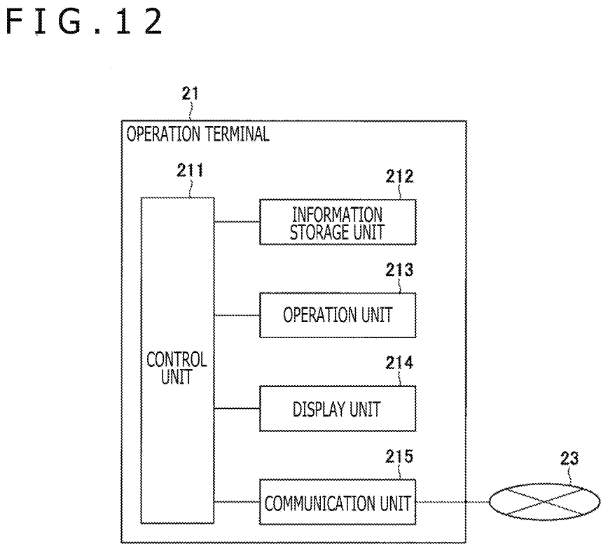

FIG. 12 is a block diagram depicting an example of the configuration of the operation terminal 21 included in the client site 20. The operation terminal 21 of the client site 20 includes a control unit 211, an information storage unit 212, an operation unit 213, a display unit 214, and a communication unit 215. Each of the operation terminal 51 of the client system operation information managing unit 50 and the operation terminal 61 included in the device information managing unit 60 basically has a configuration identical to the configuration of the operation terminal 21.

However, for the operation terminal 21 of the client site 20, presentation of a switch to a low environmental load component by the environmental load reducing system 10 is achieved by display output from the display unit 214. For example, presentation of a switch to a low environmental load component is achieved by display output of the proposal contents and the message depicted in FIG. 7 from the display unit 214 in the case of the first method described above, or achieved by display output of the proposal contents and the message depicted in FIG. 10 from the display unit 214 in the case of the second method described above.

While presentation of the switch to the low environmental load component by the environmental load reducing system 10 is achieved by the display output from the display unit 214 here, presentation of the switch to the low environmental load component by the environmental load reducing system 10 is not limited to the display output from the display unit 214. For example, presentation of the switch to the low environmental load component by the environmental load reducing system 10 may be achieved by printing output using a printing device such as a printer.

### <Environmental Load Reducing Method of Embodiment of Present Invention>

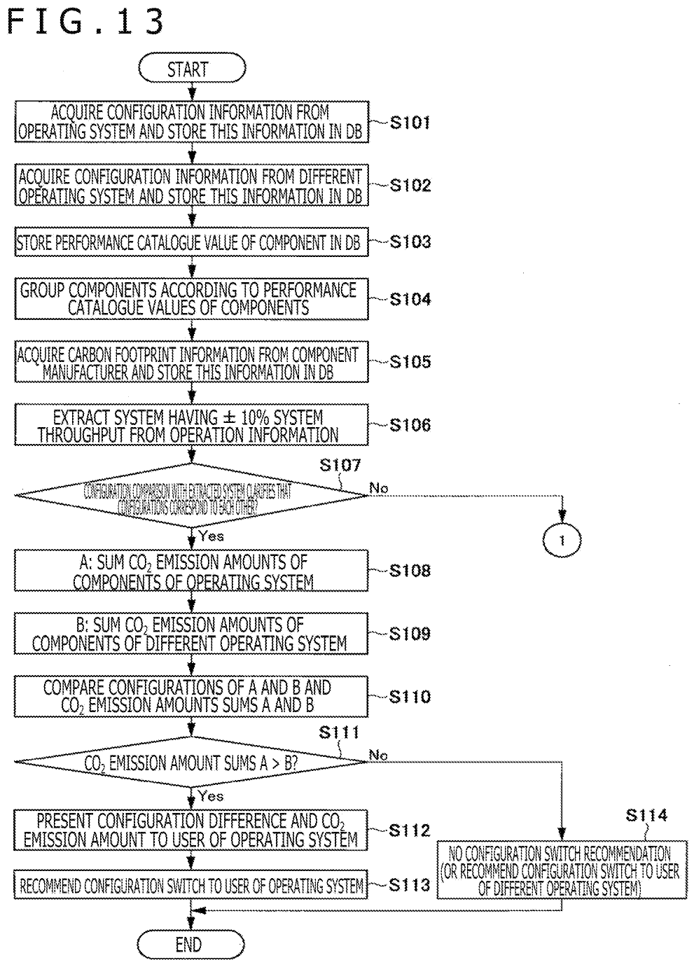

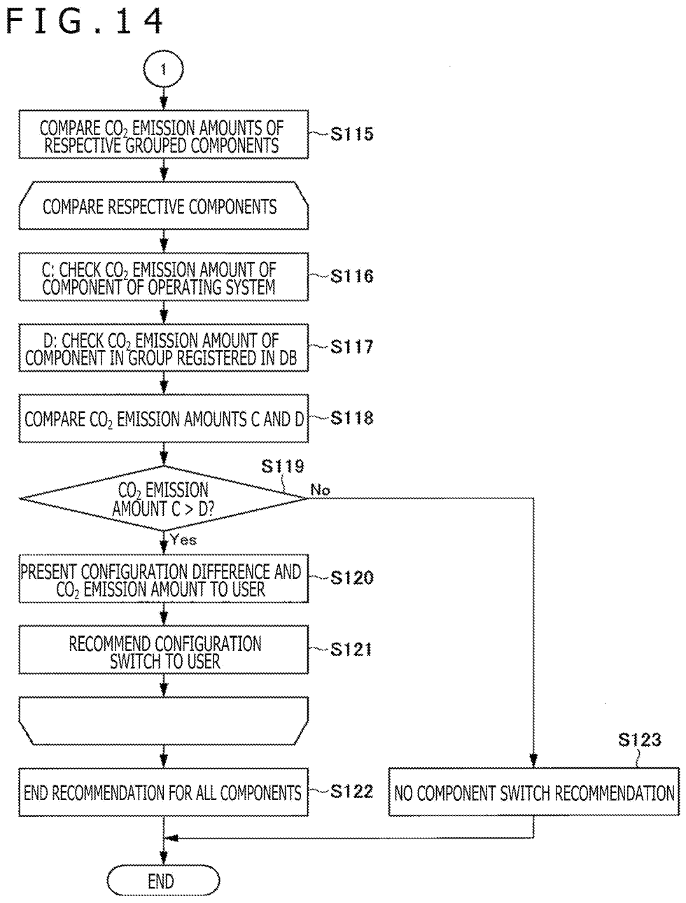

Processing procedures of an environmental load reducing method according to the embodiment of the present invention will next be described with reference to FIGS. 13 and 14. FIG. 13 is a flowchart (1) illustrating an example of the processing procedures of the environmental load reducing method according to the embodiment of the present invention, while FIG. 14 is a flowchart (2) illustrating an example of the processing procedures of the environmental load reducing method according to the embodiment of the present invention.

A series of processes of the environmental load reducing method according to the embodiment of the present invention are executed under control by the control unit 521 of the management server 52 included in the client system operation information managing unit 50 and the control unit 621 of the management server 62 included in the device information managing unit 60.

The control unit 521 of the management server 52 included in the client system operation information managing unit 50 acquires system configuration information from the operating system 22 and stores this system configuration information in a database (DB) (step S101), and then acquires system configuration information from the different operating system 41 of the different user and stores this system configuration information in the database (step S102).

Next, the control unit 521 acquires performance catalogue values of the system components and stores these values in the database (step S103), and then divides the system components into groups according to the performance catalogue values of the system components (step S104). Note that the “system components” are simply referred to as “components” in FIGS. 13 and 14 for convenience.

Subsequently, the control unit 521 acquires information indicating carbon footprints given from the component manufacturer and stores this information in the database (step S105), and then extracts a different operating system having a system throughput in a range of −10% to +10%, for example, from the operation information (step S106).

Then, the control unit 521 carries out a configuration comparison between the operating system 22 and the different operating system 41 (41_1 to 41_n) extracted in step S106 (step S107). If this configuration comparison process clarifies that the configuration of the operating system 22 corresponds to the configuration of the different operating system 41 extracted in step S106 (Yes in S107), the control unit 521 sums CO₂ emission amounts of the system components of the operating system 22 (step S108). It is assumed that the sum of the CO₂ emission amounts calculated in this step is A.

Next, the control unit 521 sums CO₂ emission amounts of the system components of the different operating system 41 (step S109). It is assumed that the sum of the CO₂ emission amounts calculated in this step is B. Subsequently, the control unit 521 obtains a configuration difference between the operating system 22 and the different operating system 41, and compares the sum A of the CO₂ emission amounts of the system components of the operating system 22 with the sum B of the CO₂ emission amounts of the system components of the different operating system 41 (step S110).

Then, the control unit 521 determines whether or not the sum A of the CO₂ emission amounts of the system components of the operating system 22 is larger than the sum B of the CO₂ emission amounts of the system components of the different operating system 41 (step S111).

If the comparison process in step S111 clarifies that the sum A is larger than the sum B (Yes in S111), the control unit 521 presents the configuration difference and the CO₂ emission amount to the user of the operating system 22 (step S112), and then recommends a system configuration switch to the user of the operating system 22 (step S113). Thereafter, the series of processes end.

If the comparison process in step S111 clarifies that the sum A is equal to or smaller than the sum B (No in S111), the control unit 521 performs processing without recommendation of a system configuration switch to the user of the operating system 22 (step S114). Thereafter, the series of processes end.

While no recommendation of a system configuration switch is given to the user of the operating system 22 in step S114 in this example when the sum A is equal to or smaller than the sum B (No in S111), the configuration difference and the CO₂ emission amount may be presented to the user of the different operating system 41 to recommend a system configuration switch to this user. In this manner, contribution to reduction of the CO₂ emission amount and reduction of power consumption is achievable also on the different user side.

If the comparison process in step S107 clarifies that the configuration of the operating system 22 does not correspond to the configuration of the different operating system 41 extracted in step S106 (No in S107), the following processing is executed under control by the control unit 621 of the management server 62 included in the device information managing unit 60.

If the configuration of the operating system 22 does not correspond to the configuration of the different operating system 41 extracted in step S106 (No in S107), the control unit 621 makes a comparison with CO₂ emission amounts of the respective system components divided into groups in step S104 (step S115). Thereafter, the process enters a loop of comparison for the respective system components.

In the loop of comparison for the respective system components, the control unit 621 checks each CO₂ emission amount of the system components of the operating system 22 (step S116). It is assumed that each CO₂ emission amount of the system components of the operating system 22 in this step is C. Next, the control unit 621 checks each CO₂ emission amount of system components in a group registered in the database (step S117). It is assumed that each CO₂ emission amount of the system components in the group in this step is D.

Subsequently, the control unit 621 compares the CO₂ emission amount C of the system component of the operating system 22 with the CO₂ emission amount D of the system component in the group (step S118), and then determines whether or not the CO₂ emission amount C is larger than the CO₂ emission amount D (step S119).

If this determination process clarifies that the CO₂ emission amount C is larger than the CO₂ emission amount D (Yes in S119), the control unit 621 presents the configuration difference and the CO₂ emission amount to the user of the operating system 22 (step S120), and then recommends a system configuration switch to the user of the operating system 22 (step S121). Thereafter, the loop of the comparison made for the respective system components ends.

Subsequently, the control unit 621 ends recommendation for all the system components (step S122), and then ends the series of processes. In addition, if the determination process in step S119 clarifies that the CO₂ emission amount C is equal to or smaller than the CO₂ emission amount D (No in S119), the control unit 621 performs processing without recommendation of a system configuration switch to the user of the operating system 22 (step S123). Thereafter, the series of processes end.

The series of processes of the environmental load reducing method according to the embodiment of the present invention described above can prompt the user of the operating system 22 to switch the system component to a low environmental load component. In this manner, the user desiring to contribute to reduction of environmental loads is enabled to examine a switch to a configuration which reduces environmental loads. Specifically, the user having received presentation of a switch of a system component can contribute to reduction of the CO₂ emission amount and reduction of power consumption by replacing the system component with a low environmental load component.

### <Modifications>

Needless to say, the present invention is not limited to the embodiment described above, and may be applied to various different application examples and modifications without departing from the subject matters of the present invention claimed in the appended claims. For example, the embodiment described above presents detailed and specific explanation of the system configurations for easy understanding of the present invention. Accordingly, all the configurations described above are not necessarily required to be adopted. Moreover, other configurations may be added to a part of the configurations of the present embodiment, or deletion or replacement of a part of the configurations of the present embodiment may be made.

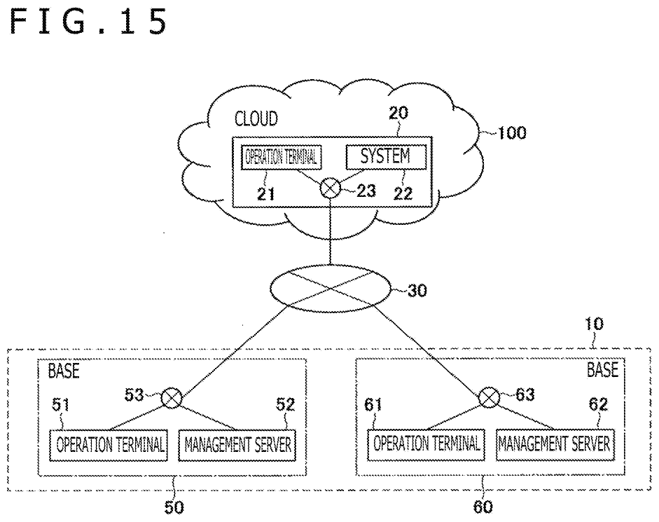

For example, while the environmental load reducing system 10 in the embodiment described above by way of example has been the system configuration which has the client site 20 including the operating system 22 and being provided on the premises, the client site 20 is not required to be provided on the premises. For example, as depicted in FIG. 15, also adoptable is such a system configuration which has the client site 20 including the operating system 22 and being provided in a cloud 100.

What is claimed is:

1. An environmental load reducing system comprising:
a detection unit that compares configuration information associated with an operating system operated by a user with configuration information associated with a different operating system of a different user, to detect a difference between system components of the operating system and the different operating system;
a comparison unit that compares a calculation result of a carbon dioxide emission amount emitted by operation of the operating system for a fixed period of time with a calculation result of a carbon dioxide emission amount emitted by operation of the different operating system for the fixed period of time; and
a presentation unit that presents a different system component as a low environmental load component according to the difference between the system components and in reference to a comparison result obtained by the comparison unit.

2. The environmental load reducing system according to claim 1, wherein the different operating system is a system that has a performance value substantially equivalent to a performance value of the operating system.

3. The environmental load reducing system according to claim 2, wherein the presentation unit presents the system component that is included in the different operating system and that is different from the corresponding system component of the operating system to the user, as the low environmental load component, when the calculation result of the carbon dioxide emission amount of the different operating system is smaller than the calculation result of the carbon dioxide emission amount of the operating system.

4. The environmental load reducing system according to claim 2, wherein the presentation unit presents the system component that is included in the operating system and that is different from the corresponding system component of the different operating system to the different user, as the low environmental load component, when the calculation result of the carbon dioxide emission amount of the operating system is smaller than the calculation result of the carbon dioxide emission amount of the different operating system.

5. An environmental load reducing system comprising:
a grouping unit that divides system components mountable on an operating system operated by a user into groups according to single performance values of the system components;
a comparison unit that compares a carbon dioxide emission amount of each of the system components mounted on the operating system with a carbon dioxide emission amount of a system component in a group identical to the group of the corresponding system component mounted on the operating system; and
a presentation unit that presents a low environmental load component to the user, wherein,
when a system component that has a smaller carbon dioxide emission amount than the corresponding system component mounted on the operating system is included in the system components in the identical group, the presentation unit presents the system component that has the smaller carbon dioxide emission amount to the user as the low environmental load component.

6. An environmental load reducing method comprising:
a step of comparing configuration information associated with an operating system operated by a user with configuration information associated with a different operating system of a different user, to detect a difference between system components of the operating system and the different operating system;
a step of comparing a calculation result of a carbon dioxide emission amount emitted by operation of the operating system for a fixed period of time with a calculation result of a carbon dioxide emission amount emitted by operation of the different operating system for the fixed period of time; and
a step of presenting a different system component as a low environmental load component according to the difference between the system components and in reference to a result of the comparison.
